(19) United States
(12) Patent Application Publication
(10) Pub. No.: US 2007/0124236 A1
(43) Pub. Date: May 31, 2007

(54) Credit risk profiling method and system

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/289,604

(22) Filed: Nov. 30, 2005

(51) Int. Cl. G06Q 40/00

(52) U.S. Cl. 705/38

(57) ABSTRACT

A method is provided for a credit risk profiling system. The method may include establishing a credit risk process model indicative of interrelationships between one or more credit risks and a plurality of financial parameters and obtaining a set of values corresponding to the plurality of financial parameters. The method may also include calculating the values of the one or more credit risks simultaneously based upon the set of values corresponding to the plurality of financial parameters and the credit risk process model, presenting the values of the one or more credit risks, and simultaneously presenting financial return information.

### TECHNICAL FIELD

This disclosure relates generally to computer based credit risk profiling techniques and, more particularly, to methods and systems for process model approach to profiling credit risks.

### BACKGROUND

Credits or loans, such as mortgages, credit cards, business loans, etc., are provided by financial institutions to individuals or other institutions in return for principal and interest payments. The credits or loans may have risk of being defaulted, which may cause certain losses for the financial institutions. To minimize the risk of defaulting, credit risk profiling may be used to analyze such risk based on a collection of a large amount of information on credit users.

Credit risk profiling may be performed by various techniques, such as empirical techniques, data mining techniques, or decision tree techniques, etc. For example, U.S. Pat. No. 6,513,018 issued to Culhane on Jan. 28, 2003, describes a statistical strategy for generating a credit score predictive of the likelihood of a desired performance result for a selected credit user. However, such conventional techniques often fail to address inter-correlation between various variables within the collected credit user information, especially at the time of generation and/or optimization of process models, to correlate certain credit user information to certain credit risks simultaneously.

Methods and systems consistent with certain features of the disclosed systems are directed to solving one or more of the problems set forth above.

### SUMMARY OF THE INVENTION

One aspect of the present disclosure includes a method for a credit risk profiling system. The method may include establishing a credit risk process model indicative of interrelationships between one or more credit risks and a plurality of financial parameters and obtaining a set of values corresponding to the plurality of financial parameters. The method may also include calculating the values of the one or more credit risks simultaneously based upon the set of values corresponding to the plurality of financial parameters and the credit risk process model, presenting the values of the one or more credit risks, and simultaneously presenting financial return information.

Another aspect of the present disclosure includes a computer system. The computer may include a database containing data records associating one or more credit risks and a plurality of financial parameters and a processor. The processor may be configured to establish a credit risk process model indicative of interrelationships between the one or more credit risks and the plurality of financial parameters and to obtain a set of values corresponding to the plurality of financial parameters. The processor may also be configured to calculate the values of the one or more credit risks simultaneously based upon the set of values corresponding to the plurality of financial parameters and the credit risk process model, to present the values of the one or more credit risks, and to simultaneously present financial return information.

Another aspect of the present disclosure includes a computer-readable medium for use on a computer system configured to perform a credit risk profiling procedure, the computer-readable medium having computer-executable instructions for performing a method. The method may include establishing a credit risk process model indicative of interrelationships between one or more credit risks and a plurality of financial parameters and obtaining a set of values corresponding to the plurality of financial parameters. The method may also include calculating the values of the one or more credit risks simultaneously based upon the set of values corresponding to the plurality of financial parameters and the credit risk process model, presenting the values of the one or more credit risks, and simultaneously presenting financial return information.

### BRIEF DESCRIPTION OF THE DRAWINGS

FIG. 1 is a block diagram of an exemplary credit risk profiling process environment consistent with certain disclosed embodiments;

FIG. 2 illustrates a block diagram of a computer system consistent with certain disclosed embodiments;

FIG. 3 illustrates a flowchart of an exemplary credit risk profiling model generation and optimization process consistent with certain disclosed embodiments; and

FIG. 4 shows an exemplary operational process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

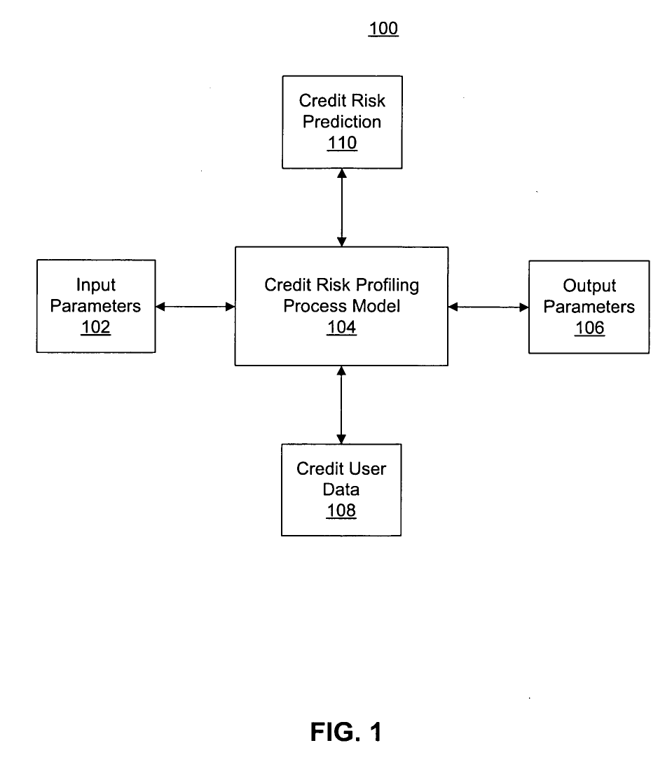

FIG. 1 illustrates a flowchart diagram of an exemplary credit risk profiling process modeling environment 100. As shown in FIG. 1, a credit risk profiling (CRP) process model 104 may be established to build interrelationships between input parameters 102 and output parameters 106. Input parameters 102 may include any appropriate type of data associated with a credit risk analysis application. For example, input parameters 102 may include information collected from credit users/customers and/or available public/private information about a credit user or a population of credit users. Input parameters 102 may also include historic and current credit information about credit customers.

Output parameters 106, on the other hand, may correspond to certain credit risks or any other types of output parameters used by the particular credit risk analysis application. For example, output parameters 106 may include likelihood of repayment, credit level, the amount of credit to be granted, the duration for extending credit, and/or the financial return based on the credit risk, etc.

CRP process model 104 may include any appropriate type of mathematical or physical model indicating interrelationships between input parameters 102 and output parameters 106. For example, CRP process model 104 may be a neural network based mathematical model that is trained to capture interrelationships between input parameters 102 and output parameters 106. Other types of mathematic models, such as fuzzy logic models, linear system models, and/or non-linear system models, etc., may also be used.

CRP process model 104 may be trained and validated using data records collected from a particular application for which CRP process model 104 is established. That is, CRP process model 104 may be established according to particular rules corresponding to a particular type of model using the data records, and the interrelationships of CRP process model 104 may be verified by using part of the data records. After CRP process model 104 is established, values of input parameters 102 may be provided to CRP process model 104 to predict values of output parameters 106 based on given values of input parameters 102 and the interrelationships.

After CRP process model 104 is trained and validated, CRP process model 104 may be optimized to define a desired input space of input parameters 102 and/or a desired distribution of output parameters 106. For example, CRP process model 104 may define limited ranges of input parameters 102 corresponding to certain credit risks, such as levels or amount of credit. The validated or optimized CRP process model 104 may be used to produce corresponding values of output parameters 106 when provided with a set of values of input parameters 102. For example, CRP process model 104 may be used to produce credit risk prediction 110 based on credit user data 108.

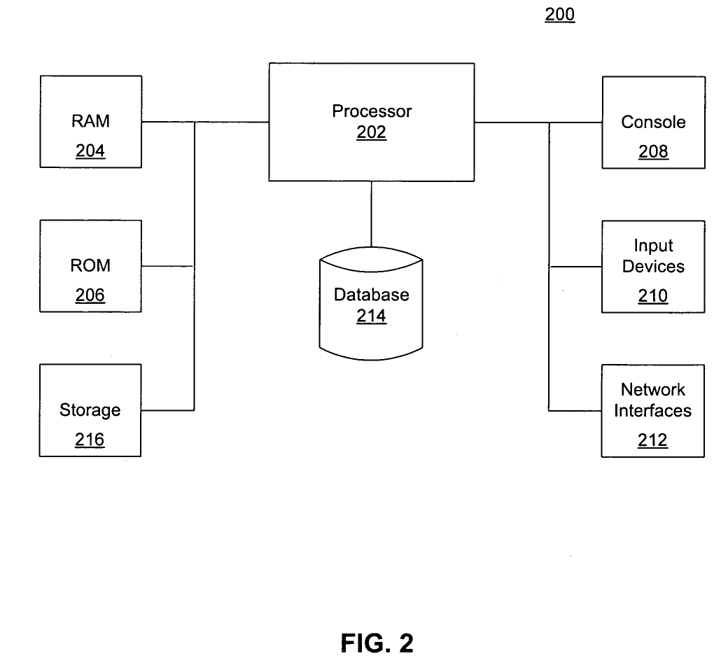

The establishment and operations of CRP process model 104 may be carried out by one or more computer systems. FIG. 2 shows a functional block diagram of an exemplary computer system 200 that may be used to perform these modeling processes and operations.

As shown in FIG. 2, computer system 200 may include a processor 202, a random access memory (RAM) 204, a read-only memory (ROM) 206, a console 208, input devices 210, network interfaces 212, a database 214, and a storage 216. It is understood that the type and number of listed devices are exemplary only and not intended to be limiting. The number of listed devices may be changed and other devices may be added.

Processor 202 may include any appropriate type of general purpose microprocessor, digital signal processor, or microcontroller. Processor 202 may execute sequences of computer program instructions to perform various processes as explained above. The computer program instructions may be loaded into RAM 204 for execution by processor 202 from read-only memory (ROM) 206, or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display device or computer monitor. Input devices 210 may be provided for users to input information into computer system 200. Input devices 210 may include a keyboard, a mouse, or other optical or wireless computer input devices, etc. Further, network interfaces 212 may provide communication connections such that computer system 200 may be accessed remotely through computer networks via various communication protocols, such as transmission control protocol/internet protocol (TCP/IP), hyper text transfer protocol (HTTP), etc.

Database 214 may contain model data and/or any information related to data records under analysis, such as training and testing data. Database 214 may include any type of commercial or customized database. Database 214 may also include analysis tools for analyzing the information in the database. Processor 202 may also use database 214 to determine and store performance characteristics of CRP process model 104.

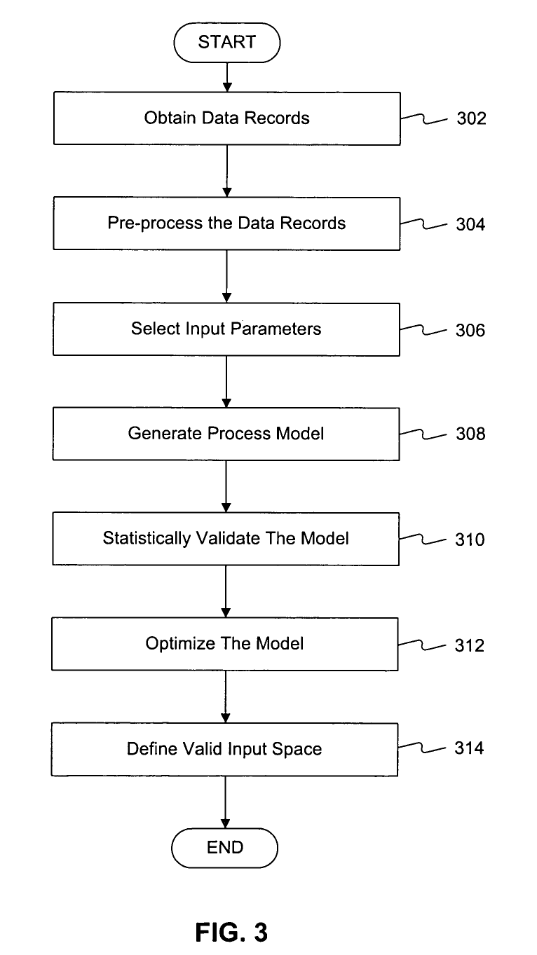

Processor 202 may perform a credit risk profiling model generation and optimization process to generate and optimize CRP process model 104. FIG. 3 shows an exemplary model generation and optimization process performed by processor 202.

As shown in FIG. 3, at the beginning of the model generation and optimization process, processor 202 may obtain data records associated with input parameters 102 and output parameters 106 (step 302). The data records may include information characterizing one or more credit users and/or a population of credit users. For example, the data records may include demographic (e.g., gender, age, education, occupation, income, etc.), geographic, and/or psychographic information, etc., about the credit users. The data records may also include parameters related to financial factors of the credit users. For example, the data records may include purchase information, price, loan amount, default, default amount, current and past customer credit, and finance records, etc.

The data records may also be collected from experiments designed for collecting such data. Alternatively, the data records may be generated artificially by other related processes, such as other financial modeling or analysis processes. The data records may also include training data used to build CRP process model 104 and testing data used to validate CRP process model 104. In addition, the data records may also include simulation data used to observe and optimize CRP process model 104.

The data records may reflect characteristics of input parameters 102 and output parameters 106, such as statistical distributions, normal ranges, and/or precision tolerances, etc. Once the data records are obtained (step 302), processor 202 may pre-process the data records to clean up the data records for obvious errors and to eliminate redundancies (step 304). Processor 202 may remove approximately identical data records and/or remove data records that are out of a reasonable range in order to be meaningful for model generation and optimization. After the data records have been pre-processed, processor 202 may select proper input parameters by analyzing the data records (step 306).

The data records may be associated with many input variables, such as any demographic, geographic, psychographic, and/or financial information, etc., about a credit user or users, from which input parameters 102 may be selected. The number of input variables may be greater than the number of input parameters 102 used for CRP process model 104. For example, data records may be associated with a broad characteristics of personal and/or public information about certain credit users, such as personal habits, consumption habits, and/or financial habits, etc.; while input parameters 102 of a particular process, such as consumer credit, may only include certain number of the broad characteristics.

A large number of input variables may significantly increase computational time during generation and operations of the mathematical models. The number of the input variables may need to be reduced to create mathematical models within practical computational time limits. In certain situations, the number of input variables in the data records may exceed the number of the data records and lead to sparse data scenarios. Some of the extra input variables may have to be omitted in certain mathematical models such that practical mathematical models may be created based on reduced variable number.

Processor 202 may select input parameters 102 according to predetermined criteria. For example, processor 202 may choose input parameters 102 by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 using any appropriate method. For example, the normal data set may include characteristic data associated with input parameters 102 that produce desired output parameters. On the other hand, the abnormal data set may include any characteristic data that may be out of tolerance or may need to be avoided. The normal data set and abnormal data set may be predefined by processor 202.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as
MDᵢ=(Xᵢ−μₓ)Σ⁻¹(Xᵢ−μ_{X})′ (1)
where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 202 may select a desired subset of input parameters such that the mahalanobis distance between the normal data set and the abnormal data set is maximized or optimized. A genetic algorithm may be used by processor 202 to search input parameters 102 for the desired subset with the purpose of maximizing the mahalanobis distance. Processor 202 may select a candidate subset of input parameters 102 based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables 102 if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 102) is selected.

After selecting input parameters 102 (e.g., gender, age, education, occupation, income, health, location, credit history, financial records, etc.), processor 202 may generate CRP process model 104 to build interrelationships between input parameters 102 and output parameters 106 (step 308). In certain embodiments, CRP process model 104 may correspond to a computational model, such as, for example, a computational model built on any appropriate type of neural network. The type of neural network computational model that may be used may include back propagation, feed forward models, cascaded neural networks, and/or hybrid neural networks, etc. Particular types or structures of the neural network used may depend on particular applications. Other types of computational models, such as linear system or non-linear system models, etc., may also be used.

The neural network computational model (i.e., CRP process model 104) may be trained by using selected data records. For example, the neural network computational model may include a relationship between output parameters 106 (e.g., credit risks, amount of credit, credit score, financial returns, etc.) and input parameters 102 (e.g., gender, age, education, occupation, income, health, location, credit history, financial records, etc.). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 310). Statistical validation may refer to an analyzing process to compare outputs of the neural network computational model with actual or expected outputs to determine the accuracy of the computational model. Part of the data records may be reserved for use in the validation process.

Alternatively, processor 202 may also generate simulation or validation data for use in the validation process. This may be performed either independently of a validation sample or in conjunction with the sample. Statistical distributions of inputs may be determined from the data records used for modeling. A statistical simulation, such as Latin Hypercube simulation, may be used to generate hypothetical input data records. These input data records are processed by the computational model, resulting in one or more distributions of output characteristics. The distributions of the output characteristics from the computational model may be compared to distributions of output characteristics observed in a population. Statistical quality tests may be performed on the output distributions of the computational model and the observed output distributions to ensure model integrity.

Once trained and validated, CRP process model 104 may be used to predict values of output parameters 106 when provided with values of input parameters 102. Further, processor 202 may optimize CRP process model 104 by determining desired distributions of input parameters 102 based on relationships between input parameters 102 and desired distributions of output parameters 106 (step 312). In particular, processor 202 may analyze the relationships between desired distributions of input parameters 102 and desired distributions of output parameters 106 based on particular applications.

For example, processor 202 may select desired ranges for output parameters 106 (e.g., favorable credit score, and/or desired amount of credit, etc.). Processor 202 may then run a simulation of the computational model to find a desired statistic distribution for an individual input parameter (e.g., gender, age, education, occupation, income, health, location, credit history, financial records, etc.). That is, processor 202 may separately determine a distribution (e.g., mean, standard variation, etc.) of the individual input parameter corresponding to the normal ranges of output parameters 106. After determining respective distributions for all individual input parameters, processor 202 may then analyze and combine the desired distributions for all the individual input parameters to determine desired distributions and characteristics for overall input parameters 102.

Alternatively, processor 202 may identify desired distributions of input parameters 102 simultaneously to maximize the possibility of obtaining desired outcomes. In certain embodiments, processor 202 may simultaneously determine desired distributions of input parameters 102 based on zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$

where x̅ᵢ represents the mean or expected value of an ith input; x̅ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, x̅ᵢ may be less than or equal to zero. A value of 3σᵢ may be added to x̅ᵢ to correct such problematic condition. If, however, x̅ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models. Under certain other circumstances, σⱼ may be equal to zero. Processor 202 may then determine that the model under optimization may be insufficient to reflect output parameters within a certain range of uncertainty. Processor 202 may assign an indefinite large number to ζ.

Processor 202 may identify a desired distribution of input parameters 102 such that the zeta statistic of the neural network computational model (i.e., CRP process model 104) is maximized or optimized. An appropriate type of genetic algorithm may be used by processor 202 to search the desired distribution of input parameters with the purpose of maximizing the zeta statistic. Processor 202 may select a candidate set of input parameters 102 with predetermined search ranges and run a simulation of CRP process model 104 to calculate the zeta statistic parameters based on input parameters 102, output parameters 106, and the neural network computational model. Processor 202 may obtain x̅ᵢ and σᵢ by analyzing the candidate set of input parameters 102, and obtain x̅ⱼ and σⱼ by analyzing the outcomes of the simulation. Further, processor 202 may obtain |Sᵢⱼ| from the trained neural network as an indication of the impact of the ith input on the jth outcome.

Processor 202 may select the candidate set of input parameters if the genetic algorithm converges (i.e., the genetic algorithm finds the maximized or optimized zeta statistic of CRP process model 104 corresponding to the candidate set of input parameters). If the genetic algorithm does not converge, a different candidate set of input parameters 102 may be created by the genetic algorithm for further searching. This searching process may continue until the genetic algorithm converges and a desired set of input parameters 102 is identified. Processor 202 may further determine desired distributions (e.g., mean and standard deviations) of input parameters 102 based on the desired input parameter set.

As explained above, output parameters 106 may include likelihood of repayment, credit level, the amount of credit to be granted, the duration for extending credit, and/or the financial return based on the credit risk, etc. The desired distributions of input parameters 102 may be determined based on certain criteria corresponding to different parameters of output parameters 106. For example, the desired distributions of input parameters 102 may be determined based on output parameter 106 that is to maximize the financial return. The desired distributions of input parameters 102 may also be determined based on output parameters 106 that is to balance between the likelihood of repayment (i.e., the risk of non-repayment) and the financial return. That is, the output parameters 106 may be optimized to achieve certain level of the financial return while having a desired level of risk of non-repayment. Other criteria, however, may also be used.

Once the desired distributions are determined, processor 202 may define a valid input space that may include any input parameter within the desired distributions (step 314). For example, processor 202 may determine that the desired distributions (i.e., desired input space) include a list of occupations, certain range of income, certain age groups, certain credit history, etc.

In one embodiment, statistical distributions of certain input parameters may be impossible or impractical to control. For example, an input parameter may be associated with a physical attribute of a credit user, such as age, or the input parameter may be associated with a constant variable within CRP process model 104 itself. These input parameters may be used in the zeta statistic calculations to search or identify desired distributions for other input parameters corresponding to constant values and/or statistical distributions of these input parameters.

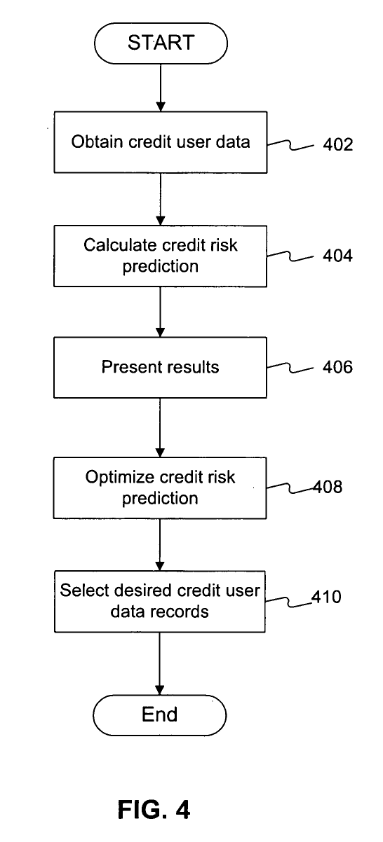

Returning to FIG. 1, after CRP process model 104 is trained, validated, and optimized, the CRP process model may be used to predict one or more credit risks (i.e., credit risk prediction 110) in response to credit user data 108. FIG. 4 shows an exemplary operational process performed by processor 202.

Processor 202 may obtain credit user data 108 (step 402). Processor 202 may obtain credit user data 108 directly from users of computer system 200, from a database, or from other computer systems maintaining such data. Credit user data 108 may reflect any relevant information about a credit user or users, such as age, sex, education, occupation, income, health, location, credit history, financial records, etc. Processor 202 may store credit user data 108 in a database, such as database 214, such that credit user data 108 may be available for operation.

After obtaining credit user data 108, processor 202 may calculate credit risk predication 110 based on CRP process model 104 (step 404). For example, processor 202 may calculate credit risks, such as whether to give or extend credit, how much credit to extend, financial return on extended credit, the duration of extended credit, and/or credit rating (e.g., credit score, etc.), based on credit user data 108 and CRP process model 104. For example, processor 202 may present the financial returns based on credit user data 108 to the users of computer system 200 (e.g., creditors, etc.).

Processor 202 may also calculate certain other statistics related to credit user data 108 and credit risk prediction 110, such as distributions or histograms of such data. For example, processor 202 may present a distribution of the financial return corresponding to distributions of other parameters, such as credit user data 108 and/or credit prediction 110.

Processor 202 may also present credit user data 108, credit risk prediction 110, and/or results of other calculation to the user or users of computer system 200 through a user interface (step 406). The user interface may include any appropriate textual, audio, and/or visual user interface. For example, the user interface may include a graphical user interface (GUI) on console 208. Credit risk prediction and interrelationships (e.g., how a set of credit user data drive certain credit risks simultaneously) may also be presented to the users of computer system 200 or creditors. Such as the interrelationships between how much financial return, how much risk of non-repayment, and user credit data 108, etc.

Alternatively, processor 202 may also directly communicate with one or more credit users corresponding to credit user data 108 to notify parts or all of credit risk prediction 110 to credit users whose data records meet certain criteria. For example, if credit risk prediction 110 indicates that credit should be extended to a particular credit user (i.e., processor 202 may determine that the calculated likelihood of repayment is beyond a predetermined threshold), processor 202 may automatically notify the particular credit user about certain information included in credit risk prediction 110. Processor 202 may notify the particular credit user that a favorable credit decision (e.g., approval on extending credit, etc.). Processor 202 may also notify the particular credit user other information, such as amount of credit to be extended, the duration for extending such credit, etc., and/or relevant business information.

Processor 202 may also optimize credit risk prediction 110 (step 408). For example, processor 202 may minimize overall credit risks by obtaining desired distributions of credit user data 108, such as desired income level, education level, age, and/or gender, credit history, etc. Processor 202 may optimize credit risk prediction 108 based on zeta statistic, as explained in above sections. A new set of values of credit user data 108 (i.e., optimized or desired credit user data) may be identified to minimize a certain type of credit risk. For example, the desired credit user data may be used to define a desired credit population. Other optimization methods, however, may also be used. For example, the user or users of computer system 200 may define a set of values of user credit data 108 (i.e., user-defined user credit data 108) based on predetermined criteria to minimize one or more credit risks.

After obtaining the desired set of values of credit user data, processor 202 may select desired credit user data records from the data base, such as database 214, with values within a certain range of the desired set of values of credit user data (step 410). The selected credit user data records may correspond to credit users who may be considered suitable or desirable to extend credit to. Credit risk prediction 110 corresponding to the selected credit user data records may also be calculated by processor 202 and the results of such calculations may be presented, as explained above. Because the selected credit user data records may be within or closer to optimized credit user data 108, credit risk prediction 110 corresponding to the selected credit user data records may also be with or closer to optimized credit user prediction 110.

### INDUSTRIAL APPLICABILITY

The disclosed systems and methods may provide efficient and accurate credit risk profiling based on a large variety of information such as personal information, public information, and/or financial factors (both current and historical). Such technology may be used to obtain an individual credit risk profile, the risk of an individual in paying back the credit extended. The technology may also be used to manage credit risks of a group or a population of credit customers.

Financial institutions or other organizations may use the disclosed systems and methods to calculate credit risks of an individual user or credit risks among a population, such as a particular credit risk distribution among the population, to reduce exposure to such risks. The institutional users may also optimize the credit risk distribution to reduce the credit risks of a population and/or to promote healthy financial behavior.

Credit users may also use the disclosed systems and methods to check potential credit risks before making a financial decision involving credit. The individual users may also be able to reduce the credit risks by changing relevant credit data (e.g., change the income or occupation) corresponding to the credit risks.

The disclosed systems and methods may also be extended to be used in non-financial field to predict or optimize other risks, such as credit risks, business risks, and/or other financial risks, etc. Parts of the disclosed system or steps of the disclosed method may be used by computer system providers to facilitate or integrate other process models.

Other embodiments, features, aspects, and principles of the disclosed exemplary systems will be apparent to those skilled in the art and may be implemented in various environments and systems.

What is claimed is:

1. A method for a credit risk profiling system, comprising:
establishing a credit risk process model indicative of interrelationships between one or more credit risks and a plurality of financial parameters;
obtaining a set of values corresponding to the plurality of financial parameters;
calculating the values of the one or more credit risks simultaneously based upon the set of values corresponding to the plurality of financial parameters and the credit risk process model;
presenting the values of the one or more credit risks; and
simultaneously presenting financial return information.

2. The method according to claim 1, further including:
optimizing the plurality of financial parameters to minimize the one or more credit risks simultaneously.

3. The method according to claim 1, wherein the credit risks includes financial return information, the method further including:
optimizing the plurality of financial parameters to maximize the financial return information based on the credit risk process model.

4. The method according to claim 1, wherein the credit risks includes financial return information and a risk of non-repayment, the method further including:
optimizing the plurality of financial parameters to balance between the financial return information and the risk of non-repayment based on the credit risk process model.

5. The method according to claim 2, further including:
selecting data records from a database based on the optimized plurality of financial parameters.

6. The method according to claim 1, wherein the presenting includes:
presenting a statistical distribution of financial return corresponding to distributions of the plurality of financial parameters.

7. The method according to claim 1, where the presenting includes:
communicating with a credit user associated with one or more of the plurality of parameters to notify the values of the one or more credit risks.

8. The method according to claim 1, wherein the establishing includes:
obtaining data records associated one or more financial variables and the one or more credit risks;
selecting the plurality of financial parameters from the one or more financial variables;
generating a computational model indicative of the interrelationships;
determining desired statistical distributions of the plurality of financial parameters of the computational model; and
recalibrating the plurality of financial parameters based on the desired statistical distributions.

9. The method according to claim 8, wherein selecting further includes:
pre-processing the data records; and
using a genetic algorithm to select the plurality of financial parameters from the one or more financial variables based on a mahalanobis distance between a normal data set and an abnormal data set of the data records.

10. The method according to claim 9, wherein the mahalanobis distance is determined by:
MDᵢ=(Xᵢ−μₓ)Σ⁻¹(Xᵢ−μₓ)′
provided that X represents a multivariate vector corresponding to the data records, μₓ represents the mean of X, and Σ⁻¹ represents an inverse variance-covariance matrix of X.

11. The method according to claim 8, wherein generating further includes:
creating a neural network computational model;
training the neural network computational model using the data records; and
validating the neural network computation model using the data records.

12. The method according to claim 8, wherein determining further includes:
determining a candidate set of the financial parameters with a maximum zeta statistic using a genetic algorithm; and
determining the desired distributions of the financial parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

13. The method according to claim 1, wherein the credit risks include:
whether to extend credit;
how much credit to be extended; and
over what duration to extend.

14. A computer system, comprising:
a database containing data records associating one or more credit risks and a plurality of financial parameters; and
a processor configured to:
establish a credit risk process model indicative of interrelationships between the one or more credit risks and the plurality of financial parameters;
obtain a set of values corresponding to the plurality of financial parameters;
calculate the values of the one or more credit risks simultaneously based upon the set of values corresponding to the plurality of financial parameters and the credit risk process model;
present the values of the one or more credit risks; and
simultaneously present financial return information.

15. The computer system according to claim 14, wherein, to establish the credit risk process model, the processor is further configured to:
obtain data records associated one or more financial variables and the one or more credit risks;
select the plurality of financial parameters from the one or more financial variables;
generate a computational model indicative of the interrelationships;
determine desired statistical distributions of the plurality of financial parameters of the computational model; and
recalibrate the plurality of financial parameters based on the desired statistical distributions.

16. The computer system according to claim 15, wherein, to select the plurality of financial parameters, the processor is further configured to:
pre-process the data records; and
use a genetic algorithm to select the plurality of financial parameters from the one or more financial variables based on a mahalanobis distance between a normal data set and an abnormal data set of the data records.

17. The computer system according to claim 15, wherein, to generate the computational model, the processor is further configured to:
create a neural network computational model;
train the neural network computational model using the data records; and
validate the neural network computation model using the data records.

18. The computer system according to claim 15, wherein, to determine the respective desired statistical distributions, the processor is further configured to:
determine a candidate set of the financial parameters with a maximum zeta statistic using a genetic algorithm; and
determine the desired distributions of the financial parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

19. The computer system according to claim 14, further includes:
a display device configured to present the one or more credit risks and interrelationships between the one or more credit risks and the plurality of financial parameters.

20. A computer-readable medium for use on a computer system configured to perform a credit risk profiling procedure, the computer-readable medium having computer-executable instructions for performing a method comprising:
establishing a credit risk process model indicative of interrelationships between one or more credit risks and a plurality of financial parameters;
obtaining a set of values corresponding to the plurality of financial parameters;
calculating the values of the one or more credit risks simultaneously based upon the set of values corresponding to the plurality of financial parameters and the credit risk process model;
presenting the values of the one or more credit risks; and
simultaneously presenting financial return information.

21. The computer-readable medium according to claim 20, wherein the method further includes:
optimizing the plurality of financial parameters to minimize the one or more credit risks simultaneously.

22. The computer-readable medium according to claim 20, wherein the establishing includes:
obtaining data records associated one or more financial variables and the one or more credit risks;
selecting the plurality of financial parameters from the one or more financial variables;
generating a computational model indicative of the interrelationships;
determining desired statistical distributions of the plurality of financial parameters of the computational model; and
recalibrating the plurality of financial parameters based on the desired statistical distributions.

23. The computer-readable medium according to claim 22, wherein selecting further includes:
pre-processing the data records; and
using a genetic algorithm to select the plurality of financial parameters from the one or more financial variables based on a mahalanobis distance between a normal data set and an abnormal data set of the data records.

24. The computer-readable medium according to claim 22, wherein generating further includes:
creating a neural network computational model;
training the neural network computational model using the data records; and
validating the neural network computation model using the data records.

25. The computer-readable medium according to claim 22, wherein determining further includes:
determining a candidate set of the financial parameters with a maximum zeta statistic using a genetic algorithm; and
determining the desired distributions of the financial parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.
